(19) United States
(12) Patent Application Publication
(10) Pub. No.: US 2026/0014651 A1
(43) Pub. Date: Jan. 15, 2026

(54) SENSOR DEVICE FOR MONITORING A LASER MACHINING PROCESS AND LASER MACHINING SYSTEM WITH THE SENSOR DEVICE

(71) Applicant: Precitec GmbH & Co. KG, Gaggenau (DE)

(72) Inventors: Matthias Strebel, Gaggenau (DE); Rainer KRAFT, Ettlingen (DE); Andreas BOBROWSKI, Bühl (DE); Martin BURKART, Rheinmünster (DE)

(73) Assignee: Precitec GmbH & Co. KG, Gaggenau (DE)

(21) Appl. No.: 19/264,196

(22) Filed: Jul. 9, 2025

(30) Foreign Application Priority Data
Jul. 10, 2024 (DE) 10 2024 119 604.1

(51) Int. Cl. B23K 26/70; G01J 1/42

(52) U.S. Cl. CPC B23K 26/705; G01J 1/4257

(57) ABSTRACT

A sensor device for monitoring a laser machining process by a laser beam by sensing an intensity of a process beam, the sensor device includes: an optical input; a beam splitter arrangement configured to couple out a plurality of visible partial beams with a respective visible wavelength range from the process beam; a first photosensor arrangement for sensing the intensity of the process beam in the visible wavelength range with a plurality of photosensors arranged to respectively sense an intensity of one of the visible partial beams, the beam splitter arrangement is configured to couple out a first visible partial beam with a first visible wavelength range, a second visible partial beam with a second visible wavelength range, a third visible partial beam with a third visible wavelength range, and a fourth visible partial beam with a fourth visible wavelength range to one photosensor of the first photosensor arrangement, respectively.

### CROSS-REFERENCE TO RELATED APPLICATIONS

This application claims priority to German Patent Application No. 10 2024 119 604.1 filed on Jul. 10, 2024, incorporated herein by reference in its entirety.

### TECHNICAL FIELD

The present disclosure relates to a sensor device for monitoring a laser machining process and a laser machining system with the sensor device.

### BACKGROUND

In a laser machining system, also referred to as a laser machining plant, the laser beam emitted by a laser beam source or the end of a laser guide fiber is directed and focused onto a workpiece to be machined by beam guiding and focusing optics. Machining may comprise laser welding or laser cutting. The laser machining system may comprise a laser machining head, for example a laser welding head or a laser cutting head, in which the optics are arranged. The laser machining process may comprise a laser welding process and a laser cutting process.

In order to ensure the quality of the machining, it is important to continuously monitor the laser machining process. Monitoring is typically performed by sensing and evaluating optical process emissions generated during the laser machining process. The optical process emissions include laser radiation scattered or reflected back from the workpiece, radiation generated in the infrared wavelength range of light (known as “infrared wavelength range”), e.g. temperature radiation from a melt pool, and radiation generated in the visible wavelength range of light, e.g., radiation from a plasma generated during machining. The optical process emissions may be referred to as process radiation or process beam.

The process beam is typically sensed by photosensors, such as photodiodes. The photosensors may be part of a sensor device arranged on the laser machining head. The process beam is coupled into the sensor device via the laser machining head. The photosensors each sense an intensity of the process beam in a specified wavelength range and generate a corresponding sensor signal. The sensor signal corresponds to a mean intensity of the respective wavelength range. For evaluating and monitoring, the sensor signal profiles are compared, for example, with predetermined envelopes and/or threshold values, and an error is output if a sensor signal lies outside the envelopes or exceeds or falls below a threshold value.

Due to the broadband spectral sensitivity of the photodiodes, the total intensity of the process beam is currently measured in a large wavelength range (known as the integral sensor signal or integral sensor signal value) and used for process monitoring.

### SUMMARY

The inventors have recognized that such integrated intensity sensing may be disadvantageous for precise monitoring of laser machining processes, in particular laser welding processes, in certain applications. Since the sensor signal corresponds to the mean intensity of the process beam in the sensed wavelength range, no changes in the sensor signal are detectable for certain process errors, even though there is a change in intensity at individual wavelengths in the wavelength range.

This is explained in FIG. 4. FIG. 4 shows a diagram illustrating the process beam intensity during laser welding in a broadband wavelength range (λ1 to λ3). The solid line shows the process beam intensity as a function of wavelength λ at a point in time when a process error occurs, while the dashed line shows the intensity for laser welding without the process error. On the left side of the diagram (wavelength range λ1 to λ2), the process error causes a decrease in intensity compared to the case without the process error, while on the right side (wavelength range λ2 to λ3), there is an increase in intensity compared to the case without the process error. However, if only one sensor signal for the intensity is sensed in the large or broadband wavelength range between λ1 and λ3, a change within the individual partial wavelength ranges λ1 to λ2 and λ2 to λ3 cannot be detected. Consequently, the process error and a faulty welded workpiece as a result of the process error cannot be detected either.

Furthermore, the inventors have found that, for precise monitoring of laser machining processes, the optical imaging of the machining area around the machining point onto the individual photosensors, e.g., photodiodes, is another decisive aspect. For special laser machining processes, there may be an optimal imaging or an optimal imaging range for each of the monitored wavelength ranges. In particular, it is advantageous when an image section or an imaged region from the machining area can be individually selected or set for each monitored wavelength range or for each partial beam coupled out of the process beam.

For example, there is an optimal imaging for the wavelength range for detecting the back reflection of the laser beam: Here, it may be advantageous to make the imaging approximately the same size as the point of incidence of the laser beam on the workpiece (i.e., the machining point). For example, an aperture size or the size of the sensor area may be limited to the image of the point of incidence of the laser beam on the workpiece or the size of the laser beam focus. In other words, it may be advantageous to design an aperture size or the size of the sensor area so as to correspond to the imaging of the machining point. This ensures, for example, that only process radiation from a specific region of the workpiece (e.g., from the keyhole and/or melt pool) is evaluated for this wavelength range. For other wavelengths or wavelength ranges, such as the infrared wavelength range, it is more advantageous when the imaging or the imaging area is significantly larger than the size of the machining point. This allows for the detection of effects that affect heat dissipation away from the point of incidence. However, different imaging ranges or an optimal imaging configuration require different aperture sizes or sensor area sizes for the respective wavelength range.

The inventors have also recognized that different amplification of the sensor signals is advantageous for precise monitoring of laser machining processes, in particular laser welding processes, in different wavelength ranges. For example, the sensor signal of the laser back reflection usually has a very high intensity. In comparison, the intensity of the process beam in the infrared wavelength range is orders of magnitude lower.

Such optimization is not possible or difficult to implement with optical spectrometers. Here, the process beam is typically split onto a CMOS or CCD chip or a diode array using a dispersive element. Individual adjustment of the imaging is no longer possible after the dispersive element. Behind the dispersive element, the pixel size may be used to adjust the spectral ranges sensed, but not imaging thereof. The imaging generally remains the same for all pixels and is defined by the imaging in front of the dispersive element. Individual signal amplification would in principle be possible with a diode array, such as for an arrangement with individual diodes. However, this presents the problem of crosstalk between neighboring diodes in the diode array.

Monitoring a laser machining process is also disadvantageous when only the sensed intensity of the process beam in large broadband wavelength ranges is used for this purpose. This means that certain effects or errors in the laser machining process cannot be recognized because the sensed intensity only indicates the mean intensity in the broadband wavelength range. Furthermore, the precise configuration and adjustment of the monitoring is made more difficult or impossible when using broadband wavelength ranges.

It is therefore an object of the present disclosure to provide a sensor device that allows for improved, in particular more precise, monitoring of a laser machining process and that allows for improved detection of process errors.

It is an object of the present disclosure to provide a sensor device that allows for the monitoring of a laser machining process based on intensities of a process beam sensed independently of each other or separately from each other for a plurality of different wavelength ranges.

It is an object of the present disclosure to provide a sensor device that allows for the monitoring of the laser machining process to be individually configured and/or adjusted for each of the monitored wavelength ranges of the process beam.

It is an object of the present disclosure to provide a sensor device that allows for an individually configured and/or adjustable imaging of the process beam for each of the monitored wavelength ranges.

It is an object of the present disclosure to provide a sensor device that allows for the amplification of sensor signals for each of the monitored wavelength ranges of the process beam to be individually configured and/or adjusted.

It is also an object of the present disclosure to provide a laser machining system with such a sensor device.

At least one of these objects is achieved by the subject matter of the independent claims. Advantageous embodiments and further developments are the subject matter of dependent claims.

According to one aspect of the present disclosure, a sensor device for monitoring a laser machining process by sensing an intensity of a process beam generated during the laser machining process is provided. The laser machining process is carried out for machining a workpiece, in particular a metallic workpiece, by a laser beam. The laser machining process may be a laser welding process.

The sensor device comprises: a beam splitter arrangement configured to couple at least two visible partial beams, each having one of at least two different visible wavelength ranges, and at least one infrared partial beam having an infrared wavelength range out of the process beam; a first photosensor arrangement for sensing the intensity of the process beam in the visible wavelength range with at least two photosensors arranged to sense an intensity of one of the visible partial beams; and a second photosensor arrangement for sensing the intensity of the process beam in the infrared wavelength range with at least one photosensor arranged to sense an intensity of the infrared partial beam.

According to a further aspect of the present disclosure, a laser machining system for carrying out a laser machining process is provided. The laser machining system comprises: a laser machining head configured to radiate a laser beam onto a workpiece to perform the laser machining process, and a sensor device according to aspects and embodiments of the present disclosure.

The laser machining head may include at least one beam splitter. The beam splitter may be arranged to couple a process beam generated during the laser machining process out of the beam path of the laser beam and/or to couple the process beam into the sensor device.

According to a further aspect of the present disclosure, a sensor device for monitoring a laser machining process by sensing an intensity of a process beam generated during the laser machining process is provided. The sensor device comprises a beam splitter arrangement configured to couple a plurality of visible partial beams with respective visible wavelength ranges out of the process beam; a first photosensor arrangement for sensing the intensity of the process beam in the visible wavelength range with a plurality of photosensors arranged to sense an intensity from one of the visible partial beams, wherein the beam splitter arrangement is configured to couple out a first visible partial beam with a first visible wavelength range, a second visible partial beam with a second visible wavelength range, a third visible partial beam with a third visible wavelength range, and a fourth visible partial beam with a fourth visible wavelength range to one of the photosensors of the first photosensor arrangement, respectively, and wherein the first photosensor arrangement comprises: a first photosensor arranged to sense an intensity of the first visible partial beam, a second photosensor arranged to sense an intensity of the second visible partial beam, a third photosensor arranged to sense an intensity of the third visible partial beam, and a fourth photosensor arranged to sense an intensity of the fourth visible partial beam.

Within the scope of this disclosure, a “monitored wavelength range” refers to a wavelength range of the process beam that is sensed by a photosensor of the device for monitoring the laser machining process. In particular, the intensity of the process beam in this wavelength range is sensed and a corresponding sensor signal is generated. The sensor signal may then be evaluated and/or recorded. The term “visible wavelength range” refers to a wavelength range that predominantly comprises wavelengths in the visible spectrum of light. In particular, the visible wavelength range may be or comprise a wavelength range between 350 nm and 850 nm or between 390 nm and 850 nm or between 380 nm and 800 nm. The term “infrared wavelength range” refers in particular to a wavelength range that predominantly comprises wavelengths in the infrared spectral range. However, the wavelength range is not limited to wavelengths in the infrared spectral range since temperature radiation, i.e., thermal emission of light, may also occur in other spectral ranges, e.g., the ultraviolet and visible ranges. In particular, the infrared wavelength range may be or comprise a wavelength range between 1200 nm and 2100 nm. Furthermore, “visible partial beam” refers to a partial beam in the visible wavelength range, “infrared partial beam” refers to a partial beam in the infrared wavelength range, and “back-reflection partial beam” refers to a partial beam in the back-reflection wavelength range. “Non-overlapping” wavelength ranges mean that no wavelength of one wavelength range is included in the other wavelength range. “Non-overlapping” is synonymous with “completely different from each other.” “Coupling out a partial beam” by a beam splitter arrangement means that the process beam is split at least once into two partial beams, namely into this partial beam and another partial beam, by the beam splitter arrangement. The coupled-out partial beam may have been reflected at least once and/or transmitted at least once by the beam splitter arrangement. For this purpose, the beam splitter arrangement may include at least one beam splitter. The split into two partial beams is not limited to an angle of 45° between a beam splitter and the incident beam (process beam or a partial beam of the process beam); rather, any angles are possible. The split into two partial beams may be effected by a neutral and/or non-selective beam splitter (e.g., in a ratio of 50:50 or 90:10), or selectively on the basis of a light property (e.g., on the basis of the wavelength and/or the polarization). A partial beam having “passed” a beam splitter that a part of a beam (the process beam or a partial beam of the process beam) is reflected by the beam splitter as the partial beam or is transmitted by the beam splitter as the partial beam.

The beam splitter arrangement may comprise a plurality of beam splitters. On its way from entering the sensor device to the photosensors, the light of the process beam interacts with the beam splitters. A primary beam splitter may be defined as the first beam splitter in the beam path of the process beam after entering the sensor device. The process beam is split into (exactly) two partial beams, a reflected partial beam and a transmitted partial beam. The beam splitters in the beam path of these partial beams are referred to as secondary beam splitters, and so on. With each further interaction (reflection/transmission) of one of the partial beams with another beam splitter in the beam splitter arrangement, the order of the respective beam splitter increases (beam splitter order): tertiary, quaternary, quinary, senary, septinary, etc. In a beam splitter arrangement, there may therefore be (at most) one primary beam splitter, two secondary beam splitters, four tertiary beam splitters, eight quaternary beam splitters, 16 quinary beam splitters, etc. Conversely, the “primary beam splitter order” refers to the primary beam splitter of the beam splitter arrangement, the “secondary beam splitter order” refers to the secondary beam splitters of the beam splitter arrangement, and so on. The primary beam splitter may be a beam splitter of the first beam splitter order. The secondary beam splitter may be a beam splitter of the second beam splitter order. The tertiary beam splitter may be a beam splitter of the third beam splitter order. The quaternary beam splitter may be a beam splitter of the fourth beam splitter order. The quinary beam splitter may be a beam splitter of the fifth beam splitter order. The senary beam splitter may be a beam splitter of the sixth beam splitter order.

In other words, the beam splitter order may specify the maximum number of (serial) optical interactions that a partial beam performs with the corresponding beam splitters in the beam splitter arrangement. The optical interaction may comprise transmission of the light of the process beam through the respective beam splitter and/or reflection of the light of the process beam at the respective beam splitter. The terms beam splitter order and order of the beam splitter may be synonymous.

The present disclosure is based on the idea of splitting the wavelength range of the process beam, in particular the visible wavelength range, into smaller, narrow-band wavelength ranges and individually sensing the intensity of the process beam for each of the narrow-band wavelength ranges. For this purpose, the present disclosure provides a beam splitter arrangement with the aid of which a corresponding partial beam for each of the narrow-band wavelength ranges is coupled out of the process beam and directed to a corresponding photosensor. The intensity of each partial beam is sensed by the corresponding photosensor, which may output a sensor signal corresponding to the sensed intensity.

The present disclosure may allow for the laser machining process to be monitored based on three or more, four, or at least seven wavelength ranges, and in particular based on at least two, three, or four visible wavelength ranges. This allows for more precise monitoring of the laser machining process because certain process errors can be detected better or at all.

In addition, each wavelength range may be sensed and/or processed and/or evaluated separately from the others and thus individually. The sensor signals of the different wavelength ranges may, for example, be amplified separately and/or differently from each other. This allows for each generated sensor signal to be subjected to individual amplification. Individual amplification is important because the intensities of the partial beams often vary by several orders of magnitude. For example, the laser back reflection usually has a very high intensity, while the intensity of the infrared radiation is usually several orders of magnitude lower. The present disclosure allows for individual amplification of the sensor signals of the different wavelength ranges over a wide range of orders of magnitude, for example by a factor of 10 to 10⁷.

In a further example, the optical imaging may be individually configured and adjusted for each partial beam or for each wavelength range. For this purpose, the beam splitter arrangement may be configured to couple out each of the plurality of partial beams with a predetermined optical imaging and/or an individually adjustable optical imaging to the corresponding photosensor. The beam splitter arrangement may include an imaging apparatus. The imaging apparatus may have an aperture for each partial beam. The opening of each of the apertures may be individually adjustable. The apertures may be inverse apertures. The apertures may be configured for optomechanical beam guidance and/or blocking. Furthermore, the imaging apparatus may comprise at least one optical element, for example a lens or a lens system, for each partial beam for adjusting the imaging of the partial beam onto the sensor surface of the corresponding photosensor. The beam splitter arrangement may thus be used for spatial optical filtering, beam guidance or beam blocking.

Alternatively or additionally, for each partial beam or wavelength range, a size of the sensor surface of the corresponding photosensor and/or position of the sensor surface along the beam axis may be selected independently and/or differently from other partial beams or wavelength ranges or may be adjustable. This allows for a section of the process region, from which the intensity of the partial beam or the monitored wavelength range is sensed, to be adjusted.

The imaging of the individual wavelength ranges can thus be spatially optimized. The individual wavelength ranges can be spatially filtered, so to speak. An optimized imaging can be selected or adjusted at the corresponding photosensor for each partial beam or each monitored wavelength range.

The aspects of the present disclosure may include one or more of the following optional features.

The sensor device may include an optical input for introducing the process beam.

The beam splitter arrangement may be configured to couple out a plurality of partial beams with different wavelength ranges from the process beam. The wavelength ranges of the partial beams coupled out by the beam splitter arrangement may be completely different from each other, i.e., they do not overlap each other. The wavelength ranges of the partial beams coupled out by the beam splitter arrangement may be between 50 nm and 200 nm or between 50 and 100 nm wide.

The beam splitter arrangement may be configured to couple out a back-reflection partial beam with the back-reflection wavelength range from the process beam.

The sensor device may comprise a third photosensor arrangement for sensing the intensity of the process beam in the back-reflection wavelength range. The third photosensor arrangement may comprise a photosensor arranged to sense an intensity of the back-reflection partial beam.

The back-reflection wavelength range may comprise the wavelength of the laser beam and/or a wavelength range from 950 nm to 1150 nm, from 1000 nm to 1100 nm, or comprise a wavelength range in the green spectral range or in the blue spectral range. The beam splitter arrangement may be configured to direct the back-reflected partial beam to the photosensor of the third photosensor arrangement. The laser beam may have a wavelength in the infrared or visible, in particular green or blue, spectral range.

The visible wavelength range and the infrared wavelength range or the visible wavelength range, the infrared wavelength range and the back-reflection wavelength range may be completely different from each other, i.e. not overlapping each other.

The first photosensor arrangement may include a plurality of photosensors for sensing the intensity of the process beam in the visible wavelength range. The first photosensor arrangement may include a photosensor for each visible partial beam coupled out of the process beam by the beam splitter arrangement in order to sense the intensities of the plurality of visible partial beams separately from one another.

The second photosensor arrangement may comprise a plurality of photosensors for sensing the intensity of the process beam in the infrared wavelength range. The second photosensor arrangement may comprise a photosensor for each infrared partial beam coupled out of the process beam by the beam splitter arrangement in order to sense the intensities of the plurality of temperature partial beams separately from one another.

The beam splitter arrangement may be configured to couple out a first visible partial beam with a first visible wavelength range and a second visible partial beam with a second visible wavelength range to one of the photosensors of the first photosensor arrangement, respectively. The beam splitter arrangement may be further configured to couple out a third visible partial beam with a third visible wavelength range to a third photosensor of the first photosensor arrangement. The beam splitter arrangement may be further configured to couple out a fourth visible partial beam with a fourth visible wavelength range to a fourth photosensor of the first photosensor arrangement.

The first photosensor arrangement may comprise a first photosensor arranged to sense an intensity of the first visible partial beam and a second photosensor arranged to sense an intensity of the second visible partial beam. The first photosensor arrangement may further comprise a third photosensor arranged to sense an intensity of the third visible partial beam. The first photosensor arrangement may further comprise a fourth photosensor arranged to sense an intensity of the fourth visible partial beam.

One of the visible wavelength ranges may be completely included in at least one other visible wavelength range. The visible wavelength ranges may be the same. The visible wavelength ranges may be imaged differently onto the corresponding photosensors.

The plurality of visible wavelength ranges may be different from each other and/or may not overlap each other. If present, the first, second, third, and/or fourth visible wavelength ranges may be completely different from each other, i.e., not overlapping each other. The first visible wavelength range, the second visible wavelength range, the third visible wavelength range, and the fourth visible wavelength range may be different from each other and/or not overlap each other and/or be adjacent to each other in this order. In particular, the first visible wavelength range and the second visible wavelength range may be adjacent to each other and/or the second visible wavelength range and the third visible wavelength range may be adjacent to each other, and/or the third visible wavelength range and the fourth visible wavelength range may be adjacent to each other. By separately sensing the intensity in a plurality of visible wavelength ranges, previously unconsidered and/or unrecognizable effects, processes, and errors of the laser machining process can be sensed and monitored.

The different wavelength ranges of the visible partial beams may be selected from: 350 nm to 450 nm, 450 nm to 550 nm, 550 nm to 650 nm, and 650 nm to 850 nm. The plurality of visible wavelength ranges, in particular the first, second, third, and/or fourth visible wavelength ranges, may each include at least one wavelength selected from: 400 nm, 500 nm, 600 nm, 700 nm, 750 nm, 800 nm, a wavelength of a component of a workpiece machined by the laser machining process, in particular a steel alloy or components of a steel alloy or an aluminum alloy or components of an aluminum alloy, a wavelength of an emission band of aluminum oxide, a wavelength of an emission band of iron oxide, and a wavelength of an atomic emission line, in particular of titanium, copper, aluminum, or iron. The first visible wavelength range may comprise 400 nm, and/or the second visible wavelength range may comprise 500 nm, and/or the third visible wavelength range may comprise 600 nm, and/or the fourth wavelength range may comprise 750 nm.

The beam splitter arrangement may be configured to couple out at least one infrared partial beam with an infrared wavelength range from the process beam. The sensor device may further comprise: a second photosensor arrangement for sensing the intensity of the process beam in the infrared wavelength range with at least one photosensor arranged to sense an intensity of the infrared partial beam.

The beam splitter arrangement may be configured to couple out a first infrared partial beam with a first infrared wavelength range and a second infrared partial beam with a second infrared wavelength range to one of the photosensors of the second photosensor arrangement, respectively. The second photosensor arrangement may be configured to sense an intensity of the process beam in the first infrared wavelength range and in the second infrared wavelength range. The second photosensor arrangement may comprise at least two photosensors. The second photosensor arrangement may comprise at least two photosensors arranged to sense an intensity of one of the infrared partial beams, respectively. The second photosensor arrangement may comprise a first photosensor arranged to sense an intensity of the first infrared partial beam and a second photosensor arranged to sense an intensity of the second infrared partial beam.

The first infrared wavelength range and the second infrared wavelength range may be (completely) different from each other and/or adjacent to each other in that order. One of the infrared wavelength ranges may also be completely included in the respective other infrared wavelength range. The first infrared wavelength range and the second infrared wavelength range may be the same. The first infrared wavelength range and the second infrared wavelength range may be imaged differently onto the corresponding photosensors. The at least two infrared wavelength ranges, in particular the first and/or second infrared wavelength range, may each include at least one wavelength selected from: 1300 nm, 1400 nm, 1500 nm, 1600 nm, 1700 nm, 1800 nm, and 1900 nm. The first infrared wavelength range may include 1500 nm and/or represent high temperatures. The second infrared wavelength range may include 1900 nm and/or represent low temperatures. By sensing the intensity in two infrared wavelength ranges, heat conduction (dissipation) effects can be better sensed and monitored. The second infrared partial beam may be used, for example, to monitor effects and processes that occur in the wider environment of the machining area of the workpiece, such as during laser welding at a greater distance from the keyhole or the melt pool. In addition, it may be used to sense and monitor areas of the workpiece that are glowing faintly. The first infrared beam may be used, for example, to monitor effects and processes that occur at or in the machining point of the workpiece, for example in or in the immediate vicinity of the keyhole and/or in the melt pool. It may also be used to sense and monitor areas of the workpiece that are glowing brightly.

The fourth visible wavelength range, the back-reflection wavelength range, and the first infrared wavelength range may be non-overlapping and/or may be adjacent to each other in this order. In particular, the fourth visible wavelength range and the back-reflection wavelength range may be adjacent to each other, and the back-reflection wavelength range and the first infrared wavelength range may be adjacent to each other.

The beam splitter arrangement may be configured to couple out a plurality of partial beams from the process beam. The beam splitter arrangement may comprise a plurality of beam splitters, in particular dichroic beam splitters. The beam splitters may be configured as partially transparent mirrors. The beam splitters may each have a coating specific to wavelength range, e.g., a dichroic coating, wherein the coating specific to wavelength range is reflective or transmissive for a predetermined wavelength range. In particular, the beam splitters may each have different coatings. As a result, each beam splitter couples out a partial beam with a specific wavelength or with a specific wavelength range.

According to embodiments, the beam splitter arrangement may comprise at least three or at least four or at least five or at least six beam splitters. The beam splitter arrangement may comprise beam splitters of the primary to tertiary beam splitter orders or of the first to third beam splitter orders. The beam splitter arrangement may comprise beam splitters of the primary to senary beam splitter orders or of the first to sixth beam splitter orders.

According to embodiments, each of the beam splitters may be arranged on the beam axis of the process beam entering through the optical input and/or on an optical axis defined by the optical input and/or by a focusing optics. The beam splitters may be arranged sequentially along the beam axis of the process beam or along an axis parallel to the beam axis of the process beam.

The beam splitter arrangement may include one primary, one secondary, and one tertiary beam splitter. The beam splitter arrangement may include exactly one primary, one secondary, and one tertiary beam splitter. The beam splitter arrangement may therefore include exactly one beam splitter from each of the first, second, and third beam splitter orders.

The beam splitter arrangement may include one primary, one secondary, one tertiary, one quaternary, one quinary, one senary, etc. beam splitter, respectively. The beam splitter arrangement may include exactly one primary, exactly one secondary, exactly one tertiary, exactly one quaternary, exactly one quinary, exactly one senary, etc. beam splitter. The beam splitter arrangement may therefore include exactly one beam splitter from each of the first, second, third, fourth, fifth, and sixth beam splitter orders. In other words, the beam splitter arrangement may comprise a serial arrangement of beam splitters of the first to the sixth beam splitter orders.

The beam splitter arrangement may comprise beam splitters of the primary to quaternary or first to fourth beam splitter orders. The beam splitter arrangement may comprise a primary beam splitter. The beam splitter arrangement may further comprise a first secondary beam splitter on the beam axis of the partial beam transmitted by the primary beam splitter and a second secondary beam splitter on the beam axis of the partial beam reflected by the primary beam splitter. The beam splitter arrangement may further comprise a first tertiary beam splitter on the beam axis of the partial beam transmitted by the first secondary or the second secondary beam splitter, and a second tertiary beam splitter on the beam axis of the partial beam reflected by the first secondary beam splitter or by the second secondary beam splitter. The beam splitter arrangement may further comprise exactly one or at least one quaternary beam splitter on the beam axis of a partial beam that has been reflected or transmitted by the first tertiary beam splitter or by the second tertiary beam splitter.

In an alternative beam splitter arrangement, the first tertiary beam splitter and the second tertiary beam splitter may be distributed to two beam axes from the following beam axes: the beam axis of the partial beam transmitted by the first secondary beam splitter, the beam axis of the partial beam reflected by the first secondary beam splitter, the beam axis of the partial beam transmitted by the second secondary beam splitter, and the beam axis of the partial beam reflected by the second secondary beam splitter. In other words, the first tertiary beam splitter and the second tertiary beam splitter may each be arranged on a beam axis of a partial beam reflected by the secondary beam splitters or of a partial beam transmitted by the secondary beam splitters.

The beam splitter arrangement may comprise beam splitters of the primary to quaternary or first to fourth beam splitter orders. The beam splitter arrangement may comprise a primary beam splitter. The beam splitter arrangement may further comprise a first secondary beam splitter on the beam axis of the partial beam transmitted by the primary beam splitter and a second secondary beam splitter on the beam axis of the partial beam reflected by the primary beam splitter. The beam splitter arrangement may further comprise a first tertiary beam splitter, a second tertiary beam splitter, and a third tertiary beam splitter, which are distributed to three beam axes from the following beam axes: the beam axis of the partial beam transmitted by the first secondary beam splitter, the beam axis of the partial beam reflected by the first secondary beam splitter, the beam axis of the partial beam transmitted by the second secondary beam splitter, and the beam axis of the partial beam reflected by the second secondary beam splitter.

The beam splitter arrangement may include one, in particular exactly one, beam splitter of the primary or first beam splitter order.

The beam splitter arrangement may include at least two beam splitters of the secondary or second beam splitter order and/or may include at least two beam splitters of beam splitter orders higher than the secondary or second beam splitter order. The beam splitter arrangement may comprise beam splitters of the primary to quaternary or first to fourth beam splitter orders. As an alternative to the serial arrangement, the beam splitter arrangement may therefore comprise a branched arrangement of beam splitters, for example the first to the fourth beam splitter orders.

With a branched arrangement of beam splitters, a beam splitter arrangement may generate the same number of partial beams as with a serial arrangement, wherein the sum of (optical) interactions of the partial beams with the beam splitters is reduced. This is advantageous in that every optical interaction is associated with intensity losses and may cause imaging errors. In other words, the light yield of the beam splitter arrangement can be improved in the branched arrangement of the beam splitters compared to the serial arrangement of the beam splitters. In addition, the branched arrangement can be implemented in a more compact manner or with a smaller form factor, if necessary. In one embodiment, the sensor device may comprise, for example, six beam splitters for generating seven partial beams to be measured.

In this embodiment, with a serial arrangement of the beam splitters, exactly one beam splitter from the first to the sixth beam splitter orders may be included. This allows for a first partial beam to undergo one interaction (with the primary beam splitter), a second partial beam to undergo two interactions (one interaction each with the primary beam splitter and the secondary beam splitter), a third partial beam to undergo three interactions, and a fourth partial beam, a fifth partial beam, a sixth partial beam, and a seventh partial beam to undergo four, five, six, and six interactions, respectively. In total, 27 interactions are required in a serial arrangement of the six beam splitters in order to generate seven partial beams.

In a branched arrangement of the beam splitters, one beam splitter of a first beam splitter order, two beam splitters of a second beam splitter order, and three beam splitters of a third beam splitter order may be included in this embodiment. This allows for a first partial beam to undergo two interactions (one interaction each with the primary beam splitter and the secondary beam splitter), a second partial beam to undergo three interactions (one interaction each with the primary beam splitter, the secondary beam splitter, and the tertiary beam splitter), and each of the other partial beams to also undergo three interactions. In total, 20 interactions are required in a branched arrangement of the six beam splitters in order to generate seven partial beams.

According to embodiments, the beam splitter arrangement may comprise two beam splitters of the secondary or second and tertiary or third beam splitter orders and one, in particular exactly one, beam splitter of the quaternary or fourth beam splitter order.

According to embodiments, the beam splitter arrangement may comprise beam splitters of the primary or first beam splitter order and at least the secondary or second beam splitter order or higher. The beam splitter arrangement may therefore comprise beam splitters of the primary or first beam splitter order, the secondary or second beam splitter order, etc.

According to embodiments, the beam splitter arrangement may comprise beam splitters of the primary or first beam splitter order, the secondary or second beam splitter order, the tertiary or third beam splitter order or higher. The beam splitter arrangement may therefore comprise beam splitters of the primary or first beam splitter order, the secondary or second beam splitter order, the tertiary or third beam splitter order, etc.

According to embodiments, the beam splitter arrangement may comprise beam splitters of the primary or first beam splitter order, the secondary or second beam splitter order, the tertiary or third beam splitter order, the quaternary or fourth beam splitter order, or higher. The beam splitter arrangement may thus comprise beam splitters of the primary or first beam splitter order, the secondary or second beam splitter order, the tertiary or third beam splitter order, the quaternary or fourth beam splitter order, etc.

According to embodiments, the beam splitter arrangement of the secondary or second beam splitter order and/or higher may include exactly two, four, eight or 16 beam splitters. For example, the beam splitter arrangement of the secondary or second beam splitter order may include exactly two beam splitters, and/or may include exactly two or exactly four beam splitters of the tertiary or third beam splitter order, and may include exactly two or exactly four or exactly eight or exactly 16 beam splitters of the quaternary or fourth beam splitter order, etc.

These “branched” arrangements of beam splitters have the advantage that the total number of interactions of the individual partial beams with a beam splitter is reduced compared to a simple serial arrangement of beam splitters. A serial arrangement is characterized by the fact that there is exactly one beam splitter of each beam splitter order (primary, secondary, tertiary, etc.). In contrast, in branched arrangements, there may be a plurality of beam splitters of each beam splitter order (from the secondary or second beam splitter order onwards).

Each beam splitter may be a dichroic beam splitter. Each (primary or secondary) beam splitter may be configured to reflect (or transmit) radiation in a specified wavelength range. Each (primary or secondary) beam splitter may be configured to transmit (or reflect) radiation with wavelengths outside the specified wavelength range.

The beam splitter arrangement may comprise at least one filter arranged before or after one of the beam splitters. The beam splitter arrangement may include at least one filter specific to a wavelength range. The at least one filter specific to a wavelength range may be arranged in the beam path of at least one partial beam of the process beam.

Each of the photosensors may comprise at least one of the following elements: an optical sensor, a photodiode, a photodiode array, a CCD chip, and a CMOS chip.

The sensor surfaces of the photosensors of the first photosensor arrangement may be of different sizes.

At least two beam splitters of the beam splitter arrangement may be arranged in the beam path from the optical input to at least one photosensor. This means that for at least one photosensor, the process beam may pass through at least two beam splitters of the beam splitter arrangement before the process beam hits the photosensor as a corresponding partial beam. The process beam is thus split at least twice by the beam splitters before the partial beam hits the photosensor. This makes it easier to optimize the coatings of the two beam splitters compared to a split with only one beam splitter in the beam path to each photosensor. This is because the wavelength ranges that each of the beam splitters have to cover may be made smaller.

The sensor device may be arranged on the laser machining head. In embodiments, the sensor device may be arranged on a housing of the laser machining head. In particular, the sensor device may be flanged to the housing of the laser machining head or configured so that it can be flanged to the housing. In particular, the sensor device may be arranged on an observation port of the housing. In particular, the sensor device may be arranged coaxially with the beam axis of the laser beam. Alternatively, the sensor device may be arranged off-axis with respect to the beam axis.

Alternatively, the sensor device may be fiber-coupled. The sensor device may include light receiving optics in or on the laser machining head. The light receiving optics may be external to the laser machining head. The light receiving optics may be arranged coaxially with the beam axis of the laser beam.

Alternatively, the sensor device may be formed inside the laser.

The sensor device may comprise at least one housing. The housing may comprise the optical input. The optical input may be configured such that the process beam enters the housing of the sensor device via the optical input. The beam splitter arrangement and/or the photosensor arrangements and/or the filters may be arranged inside the housing. The sensor device may further comprise a coupling device configured to couple the sensor device to a laser machining head. The coupling device may be attached to the housing. The coupling device may, for example, comprise through holes for fasteners. The coupling device may be integrated with the housing or formed on the housing.

The sensor device may further comprise at least one focusing optics, in particular a focusing lens. The at least one focusing optics may be arranged in or on the optical input or in the beam path of the process beam between the optical input and the beam splitter arrangement. The focusing optics may thus be arranged in the beam path of the process beam before a first split of the process beam, so that the entire process beam that is entering or has entered the sensor device passes through the focusing optics.

The photosensor arrangements and/or the photosensors may each be configured to generate sensor signals corresponding to the sensed intensities. A sensor signal, in particular the strength of the sensor signal, may represent the intensity of the respective sensed wavelength range. The sensor signals may be analog signals or digital signal, in embodiments, generated by converting an analog signal. The sensor signals may be voltage signals.

The laser machining system may further comprise a control unit. The control unit may be configured to receive and/or evaluate the sensor signals. In particular, the control unit may be configured to evaluate the sensor signals separately from one another and/or to compare them with one another and/or to combine them with one another. The control unit may also be configured to perform open-loop control of the laser machining process and/or closed-loop control of the laser machining process based on the sensor signals. In particular, the control unit may be configured to detect, based on the sensor signals, whether there is a process error in the laser machining process.

The control unit may be configured to evaluate and/or record the sensor signals. The sensor signals may be evaluated separately from each other, in particular for each of the sensor signals. This means that each wavelength range may be evaluated and monitored separately. The control unit may be configured to convert the (analog) sensor signals to digital signals.

The control unit may be configured to combine the individual sensor signals of the first photosensor arrangement into a combined sensor signal. This allows for the combined sensor signal to represent the total or mean intensity of the entire visible wavelength range.

The combined sensor signal may also represent the sum of the intensity of subsets of the visible wavelength ranges. Combining may be performed by adding the sensor signal values of the individual sensor signals. The control unit may be configured to compare at least two of the individual sensor signals with each other. Comparing may be performed by forming quotients and/or subtracting the sensor signal values of the two individual sensor signals.

The photosensors may each have a sensor surface. The photosensors may each be arranged such that the sensor surface is located at a focal point of the corresponding partial beam. The sensor device may be configured such that, at a predetermined focal position of the process beam, the focus of the process beam coincides with a surface of each of the photosensors.

The laser machining system, in particular the control unit, may be configured to set an individual amplification for each sensor signal.

The laser machining process may comprise laser engraving, laser welding, laser cutting, laser soldering, or laser build-up welding on a workpiece. The workpiece may be a metallic workpiece.

### BRIEF DESCRIPTION OF THE DRAWINGS

Embodiments of the present disclosure are described below with reference to the figures. In the figures:

FIG. 1 shows a laser machining system according to embodiments of the present disclosure;

FIG. 2 shows a schematic view of a sensor device according to embodiments of the present disclosure; and

FIG. 3 shows a schematic view of a sensor device according to embodiments of the present disclosure; and

FIG. 4 shows a diagram for illustrating a sensor signal for the intensity of the process beam during laser welding in a broadband wave range.

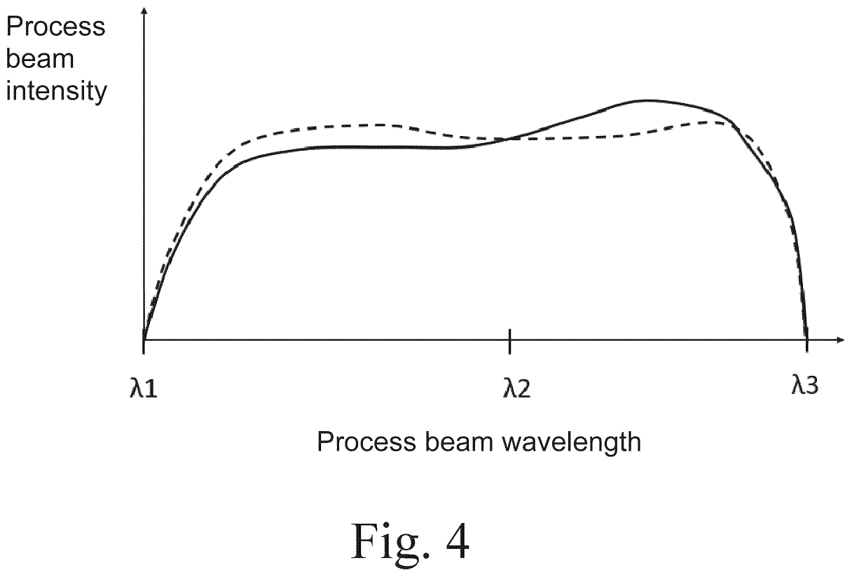

### DETAILED DESCRIPTION

Unless otherwise noted, the same reference symbols are used for identical and equivalent elements. Redundant descriptions of recurring features are avoided. The various embodiments and features of the figures described below can be combined and are not to be understood as complete implementations.

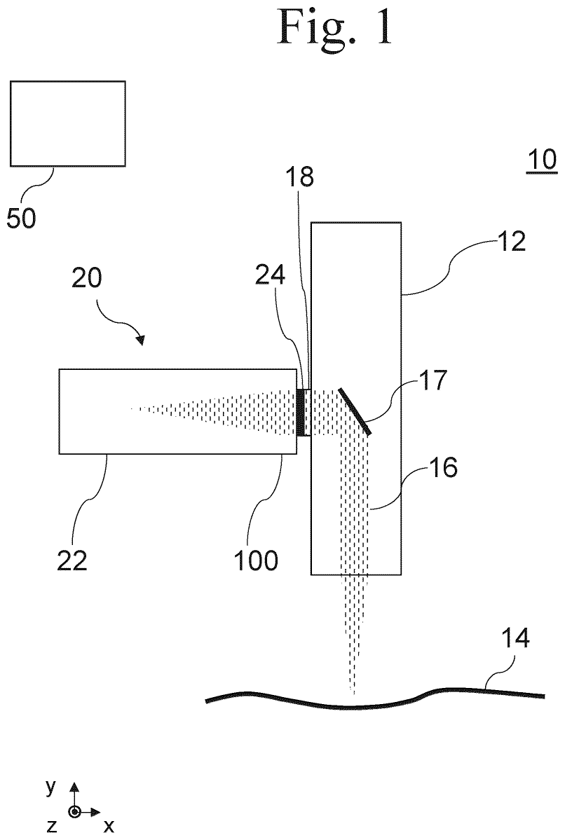

FIG. 1 shows a laser machining system according to embodiments of the present disclosure.

The laser machining system 10 is configured to perform a laser machining process and comprises a laser machining head 12. To carry out a laser machining process, a laser beam (not shown) is radiated onto a workpiece 14 and focused by the laser machining head 12, which may comprise focusing and beam shaping optics, whereby the material of the workpiece 14 is heated, melted and, optionally, vaporized. The laser machining process may comprise laser welding, laser cutting, laser soldering or laser build-up welding.

During machining, a process beam 16 is generated, which enters the laser machining head 12 and is coupled out of a beam path of the laser beam (not shown) by a beam splitter 17. The process beam 16 comprises the laser radiation scattered or reflected back by the workpiece 14, radiation in the infrared wavelength range of light, e.g. temperature radiation, and radiation in the visible wavelength range of light, e.g. radiation from plasma produced by the machining or from metal vapor highly excited by the laser beam.

To couple out the process beam 16, the laser machining head 12 may include a first coupling device 18 and an optical output (not shown). The optical output may be combined with the first coupling device 18. The process beam is coupled out via the optical output of the laser machining head 12.

The laser machining system 10 further comprises a sensor device 20 for monitoring the laser machining process by sensing an intensity of the process beam 16 generated during the laser machining process according to embodiments of the present disclosure. The sensor device 20 comprises an optical input (not shown) for introducing or coupling the process beam 16 into the sensor device 20. The optical input may be arranged on a housing 22 of the sensor device 20. The sensor device 20 may further comprise a second coupling device 24 for coupling the sensor device 20 to the laser machining head. The coupling device 24 may be combined with the optical input.

The beam splitter 17 may be arranged after a focusing optics in the beam path of the process beam 16 in the laser machining head 12. The process beam 16 may thus be coupled into the sensor device 20 in a collimated manner.

The workpiece 14 may be a metallic workpiece and may in particular comprise ferrous material, for example a steel alloy or iron, or aluminum-containing material, for example aluminum or an aluminum alloy.

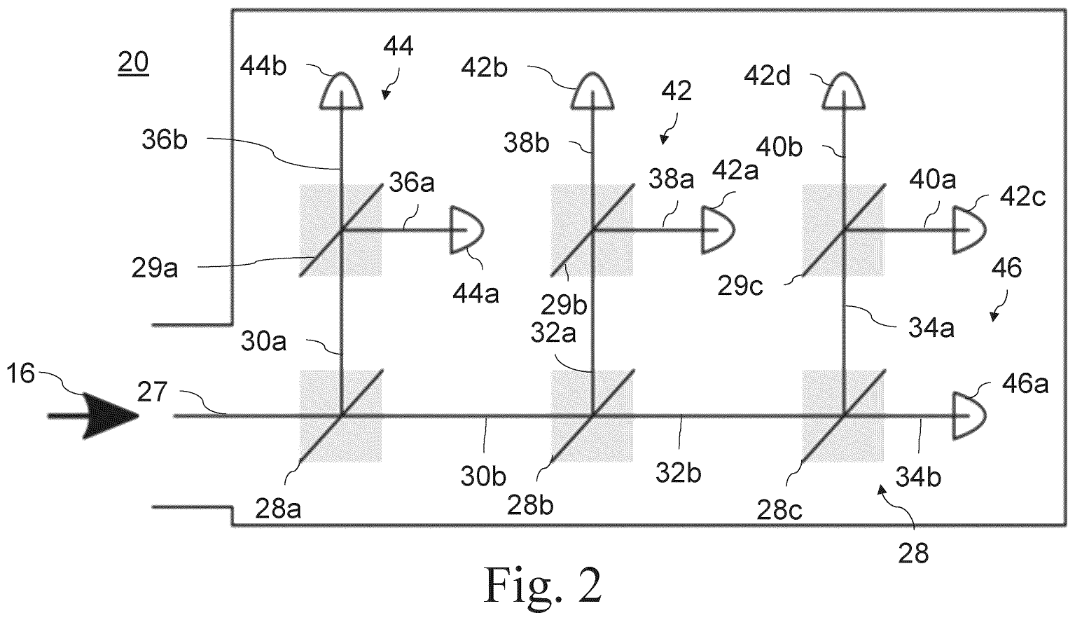

The sensor device 20 is described in detail below. FIG. 2 shows a schematic view of a sensor device according to embodiments of the present disclosure.

The sensor device 20 may comprise a focusing optics (not shown), for example a focusing lens, for focusing the process beam 16 coupled into the sensor device. The beam axis 27 of the process beam 16 coincides with an optical axis of the focusing optics. The focusing optics may be provided for focusing the process beam 16 or partial beams described later onto photosensors also described later. However, the present disclosure is not limited thereto. The process beam 16 may also enter the sensor device 20 in a collimated manner.

The sensor device 20 comprises a beam splitter arrangement 28 and a first photosensor arrangement 42 for sensing the intensity of the process beam 16 in the visible wavelength range and a second photosensor arrangement 44 for sensing the intensity of the process beam 16 in the infrared wavelength range. The sensor device 20 may further comprise, as shown in FIG. 2, a third photosensor arrangement 46 for sensing the intensity of the process beam 16 in the back-reflection wavelength range. Each of the photosensor arrangements 42, 44, 46 comprises at least one photosensor 42a, 42b, 42c, 42d, 44a, 44b, 46a. The beam splitter arrangement 28 serves to split the process beam 16 in order to couple out partial beams with different wavelength ranges from the process beam 16 and to direct them to one of the photosensors of the photosensor arrangements 42, 44, 46, respectively. A photosensor may, for example, be configured as a photodiode.

The beam splitter arrangement 28 comprises, for example, a plurality of beam splitters which are configured as partially transparent mirrors. The beam splitters may each include a reflective coating specific to a wavelength range and/or a transmissive coating specific to a wavelength range. As a result, each beam splitter of the beam splitter arrangement 28 reflects or transmits a partial beam with a specific wavelength range. The beam splitter arrangement 28 may further comprise at least one filter specific to a wavelength range (not shown) arranged in the beam path of at least one partial beam of the process beam.

The beam splitter arrangement 28 shown in FIG. 2 comprises, for example, a primary beam splitter 28a, a first secondary beam splitter 28b, and a first tertiary beam splitter 28c, which are arranged one after the other on a line or axis. The primary beam splitter 28a is arranged as the first beam splitter in the beam path of the process beam 16 along the beam axis 27 after the focusing optics. The primary beam splitter 28a splits the process beam 16 into two partial beams. A first part of the process beam 16 is reflected as a first primary reflected partial beam 30a. A second part of the process beam 16 is transmitted as a first primary transmitted partial beam 30b. A beam axis of the partial beam 30b after the beam splitter 28a may substantially coincide with or be parallel to the beam axis of the process beam 16 entering the sensor device 20 before the primary beam splitter 28a.

The first secondary beam splitter 28b is arranged in the beam path of the partial beam 30b transmitted by the beam splitter 28a. The beam splitter 28b splits the transmitted partial beam 30b into two parts. A first part of the partial beam 30b is reflected as a first secondary reflected partial beam 32a. A second part of the partial beam 30b is transmitted as a first secondary transmitted partial beam 32b. A beam axis of the partial beam 32b after the beam splitter 28b may substantially coincide with or be parallel to the beam axis of the partial beam 30b before the beam splitter 28b and/or with the beam axis of the process beam 16 before the beam splitter 28a.

The first tertiary beam splitter 28c is arranged in the beam path of the partial beam 32b transmitted by the beam splitter 28b. The beam splitter 28c splits the transmitted partial beam 32b into two parts. A first part of the partial beam 32b is reflected as a first tertiary reflected partial beam 34a. A second part of the partial beam 32b is transmitted as a first tertiary transmitted partial beam 34b. A beam axis of the partial beam 34b after the beam splitter 28c may substantially coincide with or be parallel to the beam axis of the partial beam 32b before the beam splitter 28c and/or with the beam axis of the process beam 16 before the beam splitter 28a.

The beam splitter arrangement further comprises a second secondary beam splitter 29a, a second tertiary beam splitter 29b, and a quaternary beam splitter 29c. The second secondary beam splitter 29a is arranged in the beam path of the partial beam 30a reflected by the primary beam splitter 28a. The beam splitter 29a splits the reflected partial beam 30a into two parts. A first part of the partial beam 30a is reflected as a second secondary reflected partial beam 36a. A second part of the partial beam 30a is transmitted as a second secondary transmitted partial beam 36b. A beam axis of the partial beam 36b after the beam splitter 29a may substantially coincide with or be parallel to the beam axis of the partial beam 30a before the beam splitter 29a.

The second tertiary beam splitter 29b is arranged in the beam path of the partial beam 32a reflected by the first secondary beam splitter 28b. The beam splitter 29b splits the reflected partial beam 32a into two parts. A first part of the partial beam 32a is reflected as a second tertiary reflected partial beam 38a. A second part of the partial beam 32a is transmitted as a second tertiary transmitted partial beam 38b. A beam axis of the partial beam 38b after the beam splitter 29b may substantially coincide with or be parallel to the beam axis of the partial beam 32a before the beam splitter 29b.

The quaternary beam splitter 29c is arranged in the beam path of the partial beam 34a reflected by the first tertiary beam splitter 28c. The beam splitter 29c splits the reflected partial beam 34a into two parts. A first part of the partial beam 34a is reflected as a quaternary reflected partial beam 40a. A second part of the partial beam 34a is transmitted as a quaternary transmitted partial beam 40b. A beam axis of the partial beam 40b after the beam splitter 29c may substantially coincide with or be parallel to the beam axis of the partial beam 34a before the beam splitter 29c.

The beam splitter arrangement 28 is not limited to the embodiment shown in FIG. 2.

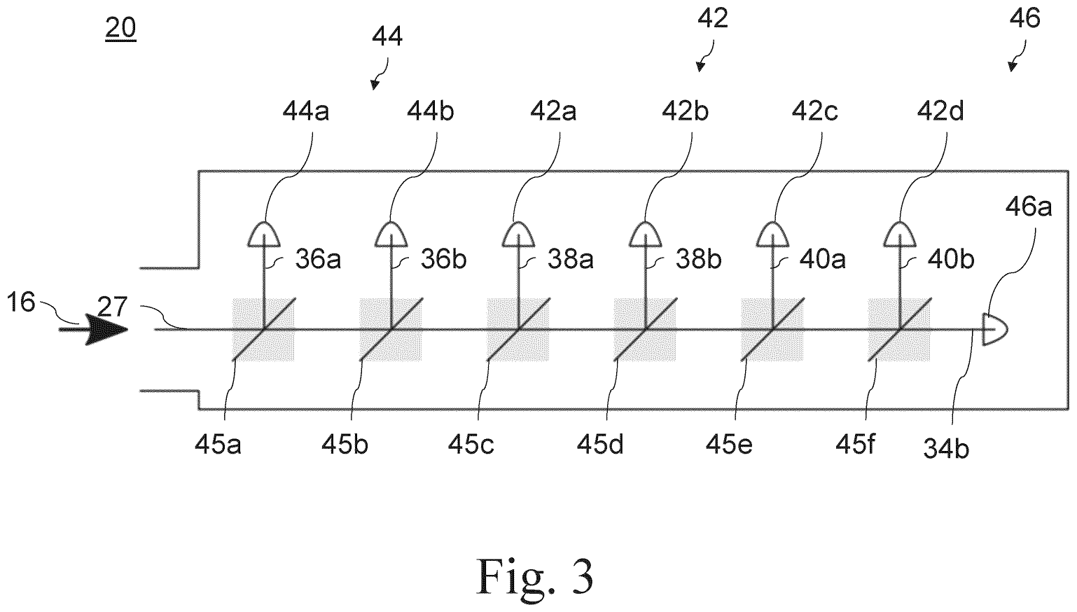

FIG. 3 shows a further embodiment of a sensor device. Here, the beam splitter arrangement 28 comprises six beam splitters arranged one after the other along the beam axis 27 of the process beam 16 entering the sensor device 20. The sensor device of FIG. 3 comprises a primary beam splitter 45a, a secondary beam splitter 45b, a tertiary beam splitter 45c, a quaternary beam splitter 45d, a quinary beam splitter 45e, and a senary beam splitter 45f. Each of the primary to quinary beam splitters 45a-45e serves to couple out a corresponding partial beam 36a, 36b, 38a, 38b, 40a, 40b. The senary beam splitter serves to couple out the partial beams 40b and 46a.

The partial beams 38a, 38b, 40a, 40b have different visible wavelength ranges. These partial beams are used to sense intensities of the process beam 16 in the different visible wavelength ranges and may therefore also be referred to as visible partial beams. For example, the first partial beam 38a may have a first visible wavelength range around 400 nm and may be used to sense atomic emission lines, in particular atomic emission lines of aluminum or iron. The second partial beam 38b may have a second visible wavelength range around 500 nm and may, for example, be used to sense molecular emission bands, for example of aluminum oxide. The third partial beam 40a may have a third visible wavelength range around 600 nm and may be used to sense molecular emission bands, for example of iron oxide. The fourth partial beam 40b may have a fourth visible wavelength range around 750 nm. The fourth visible wavelength range may extend into the near-infrared range.

The beam splitter arrangement 28 shown couples out four visible partial beams. However, the present disclosure is not limited thereto. The beam splitter arrangement 28 may, for example, also couple out only two visible partial beams, for example the first visible partial beam 38a and the second visible partial beam 38b or the first visible partial beam 38a and the third visible partial beam 40a.

The partial beams 36a, 36b have infrared wavelength ranges that are different from each other. These partial beams are used to sense intensities of the process beam 16 in the different infrared wavelength ranges and may therefore also be referred to as infrared partial beams. The first infrared partial beam 36a may have an infrared wavelength range around 1500 nm. This infrared partial beam 36a may be used to sense temperature radiation representing a high temperature. This allows, for example, for effects and processes occurring in the area of the keyhole and/or the melt pool to be monitored. The second infrared partial beam 36b may have an infrared wavelength range around 1900 nm. This infrared partial beam 36b may be used to sense temperature radiation that includes low temperatures. This allows, for example, for effects and processes to be monitored that affect heat conduction from the point of incidence of the laser beam on the workpiece or from the keyhole or melt pool.

The partial beam 34b has the wavelength of the laser beam. It is used to sense an intensity of the back reflection of the laser beam from the workpiece 14 as part of the process beam 16 and may therefore also be referred to as the back-reflection partial beam 34b.

The beam splitter arrangement 28 directs the partial beams 38a, 38b, 40a, 40b to one respective photosensor of the first photosensor arrangement 42 for sensing the intensity of the process beam 16 in the visible wavelength range. In the example shown, the first photosensor arrangement 42 includes four photosensors 42a-42d. Each of the four photosensors 42a-42d is arranged to sense the intensity of exactly one of the partial beams 38a, 38b, 40a, 40b. For example, the first photosensor 42a senses the intensity of the first visible partial beam 38a, and so on. Due to the configuration of the beam splitter arrangement 28, which couples out the different partial beams 38a, 38b, 40a, 40b with different visible wavelength ranges from the process beam 16, the intensities of the different visible wavelength ranges can still be detected and monitored separately from one another.

The beam splitter arrangement guides the partial beams 36a, 36b to one photosensor of the second photosensor arrangement 44, respectively, for sensing the intensity of the process beam 16 in the infrared wavelength range. In the example shown, the second photosensor arrangement 44 includes two photosensors 44a, 44b. Each of the two photosensors 44a, 44b is arranged to sense the intensity of exactly one of the partial beams 36a, 36b. For example, the first photosensor 44a senses the intensity of the first infrared partial beam 36a. Due to the configuration of the beam splitter arrangement 28, which couples out the different partial beams 36a, 36b with different visible wavelength ranges from the process beam 16, the intensities of the different infrared wavelength ranges can still be sensed and monitored separately from one another. However, the two photosensors 44a, 44b may have different sensor surface sizes. In particular, the first photosensor 44a may have a sensor surface that is limited to imaging the machining area, e.g., the keyhole or the melt pool. The second photosensor 44b may have a sensor surface that allows imaging of the machining area and its surroundings. In other words, the second photosensor 44b may have a larger sensor surface than the first photosensor 44a.

The beam splitter arrangement directs the partial beam 34b to a third photosensor arrangement 46 for sensing the intensity of the process beam 16 in the back-reflection wavelength range. The third photosensor arrangement 46 comprises a photosensor 46a which is arranged to detect an intensity of the back-reflection partial beam 34b.

The beam splitter arrangement 28, the photosensor arrangements 42, 44, 46 and, optionally, further filters and optical elements, such as the focusing optics, are arranged inside the housing 22 (not shown in FIG. 2).

The photosensors of all photosensor arrangements 42, 44, 46 are each configured to generate a corresponding sensor signal, for example an analog voltage signal, based on the intensity sensed in each case. For example, the voltage level may be a measure of the intensity of the wavelength range sensed in each case.

The laser machining system 10 shown in FIG. 1 may comprise a control unit 50 which receives the sensor signals of all photosensors. The control unit 50 may be configured to control the laser machining process based on the received sensor signals. In particular, the control unit may be configured to detect, based on the received sensor signals, whether a process error in the laser machining process has occurred. The control unit may further be configured to set an individual amplification for each sensor signal. In embodiments, the control unit may be an electronic control unit.

The control unit may further be configured to evaluate and/or record the sensor signals. The sensor signals may be evaluated separately for each of the sensor signals or separately from the other sensor signals. Consequently, each wavelength range may be evaluated and monitored separately.

The present disclosure relates to a sensor device for process monitoring, in particular when welding components, by recording the process beam or process emissions in a plurality of wavelength ranges. In one possible embodiment, the sensor device includes four photodiodes for the visible spectrum for sensing process emissions in the extended visible wavelength range, one photodiode for the laser wavelength range for measuring back reflections of the laser, and two photodiodes for sensing process emissions in the infrared or temperature spectral range. In one possible embodiment, a beam splitter arrangement of the sensor device may be configured in a series connection so that there are three primary beam splitters and three secondary beam splitters which further split the already split light and direct it to two channels each.

The beam splitter arrangement according to the present disclosure makes it possible to monitor laser machining processes in a plurality of wavelength ranges while optimizing the optical imaging of each individual wavelength range or channel separately from each other. The sensor device allows, for example, an configuration design of the imaging by allowing for the sensor surface size of each individual photodiode to be selected appropriately. In addition, the described device makes it possible to amplify the sensor signals of each individual photodiode separately from one another. The signal of the laser back reflection may typically have a very high intensity. In comparison, the intensity of the emission in the temperature range is usually orders of magnitude lower. In general, the partial beams may have signal intensities that differ by orders of magnitude. It is therefore advantageous when the signals of the photodiodes can be adjusted separately from one another. This is made possible by the sensor device of the present disclosure and is not or not easily achievable with typical spectrometers due to their CCD or CMOS design.

1. A sensor device for monitoring a laser machining process by a laser beam by sensing an intensity of a process beam generated during the laser machining process, the sensor device comprising:
a beam splitter arrangement configured to couple out at least four visible partial beams with a respective visible wavelength range from the process beam;
a first photosensor arrangement for sensing the intensity of the process beam in the visible wavelength range with a plurality of photosensors arranged to respectively sense an intensity of one of the at least four visible partial beams,
wherein the beam splitter arrangement is configured to couple out a first visible partial beam with a first visible wavelength range, a second visible partial beam with a second visible wavelength range, a third visible partial beam with a third visible wavelength range, and a fourth visible partial beam with a fourth visible wavelength range to one of the photosensors of the first photosensor arrangement, respectively, and
wherein the first photosensor arrangement comprises:
a first photosensor arranged to sense an intensity of the first visible partial beam,
a second photosensor arranged to sense an intensity of the second visible partial beam,
a third photosensor arranged to sense an intensity of the third visible partial beam, and
a fourth photosensor arranged to sense an intensity of the fourth visible partial beam.

2. The sensor device according to claim 1, wherein the beam splitter arrangement is further configured to couple out a back-reflection partial beam with a back-reflection wavelength range from the process beam,
wherein the sensor device further comprises a third photosensor arrangement for sensing the intensity of the process beam in the back-reflection wavelength range,
wherein the third photosensor arrangement comprises at least one photosensor arranged to sense an intensity of the back-reflection partial beam,
wherein the back-reflection wavelength range comprises a wavelength of the laser beam and/or is a wavelength range from 950 nm to 1150 nm, or wherein the back-reflection wavelength range comprises a wavelength range in a green spectral range or in a blue spectral range.

3. The sensor device according to claim 1, wherein the beam splitter arrangement is further configured to couple out at least one infrared partial beam with an infrared wavelength range from the process beam,
wherein the sensor device further comprises a second photosensor arrangement for sensing the intensity of the process beam in the infrared wavelength range with at least one photosensor arranged to sense an intensity of the infrared partial beam.

4. The sensor device according to claim 1, wherein the plurality of visible wavelength ranges do not overlap each other, and/or
wherein each of the plurality of visible wavelength ranges includes at least one wavelength selected from: 400 nm, 500 nm, 600 nm, 700 nm, 750 nm, 800 nm, a wavelength of an emission band of aluminum oxide, a wavelength of an emission band of iron oxide, and a wavelength of an atomic emission line.

5. The sensor device according to claim 1, wherein the beam splitter arrangement is configured to couple out each of the plurality of partial beams to the corresponding photosensor with a predetermined optical imaging and/or an individually adjustable optical imaging.

6. The sensor device according to claim 1, wherein the beam splitter arrangement includes an imaging apparatus, wherein the imaging apparatus has an aperture for at least one partial beam and/or at least one optical element, for at least one partial beam for adjusting the imaging of the partial beam onto a sensor surface of the corresponding photosensor.

7. The sensor device according to claim 1, wherein, for each partial beam, a size of a sensor surface of a corresponding photosensor and/or a position of the sensor surface along a beam axis is selected or can be adjusted independently and/or differently from the other partial beams.

8. The sensor device according to claim 1, wherein the beam splitter arrangement is configured to couple out a first infrared partial beam with a first infrared wavelength range and a second infrared partial beam with a second infrared wavelength range different from the first infrared wavelength range;
wherein the second photosensor arrangement comprises at least two photosensors arranged to respectively sense an intensity of one of the infrared partial beams.

9. The sensor device according to claim 3, wherein the at least one infrared wavelength range includes at least one wavelength selected from: 1300 nm, 1400 nm, 1500 nm, 1600 nm, 1700 nm, 1800 nm, and 1900 nm.

10. The sensor device according to claim 1, wherein the beam splitter arrangement comprises:
at least three or at least four or at least five or at least six beam splitters.

11. The sensor device according to claim 1, wherein the beam splitter arrangement comprises a primary, a secondary, a tertiary, a quaternary, a quinary, and a senary beam splitter, which are arranged one after the other along a beam axis of the process beam.

12. The sensor device according to claim 1, wherein the beam splitter arrangement comprises at least two beam splitters of a second beam splitter order and/or from a higher beam splitter order than the second beam splitter order, wherein the beam splitter order indicates how many optical interactions a partial beam in the beam splitter arrangement performs at most with the respective beam splitters.

13. The sensor device according to claim 1, wherein the beam splitter arrangement comprises:
a primary beam splitter;
a first secondary beam splitter on the beam axis of the partial beam transmitted by the primary beam splitter and a second secondary beam splitter on the beam axis of the partial beam reflected by the primary beam splitter; and
a first tertiary beam splitter and a second tertiary beam splitter, which are distributed to two beam axes from the following beam axes: the beam axis of the partial beam transmitted by the first secondary beam splitter, the beam axis of the partial beam reflected by the first secondary beam splitter, the beam axis of the partial beam transmitted by the second secondary beam splitter, and the beam axis of the partial beam reflected by the second secondary beam splitter;
a quaternary beam splitter on the beam axis of a partial beam reflected or transmitted by the first tertiary beam splitter or by the second tertiary beam splitter; or
a first tertiary beam splitter, a second tertiary beam splitter, and a third tertiary beam splitter, which are distributed to three beam axes from the following beam axes: the beam axis of the partial beam transmitted by the first secondary beam splitter, the beam axis of the partial beam reflected by the first secondary beam splitter, the beam axis of the partial beam transmitted by the second secondary beam splitter, and the beam axis of the partial beam reflected by the second secondary beam splitter.

14. The sensor device according to claim 1, wherein each of the photosensors comprises at least one of the following elements: a photodiode, a photodiode array, a CCD chip, a CMOS chip, and an optical sensor.

15. The sensor device according to claim 1, wherein the beam splitter arrangement comprises at least one beam splitter having a coating specific to a wavelength range, and/or
wherein the beam splitter arrangement comprises at least one filter specific to a wavelength range which is arranged in the beam path of at least one partial beam of the process beam, and/or
wherein the process beam passes through at least two beam splitters of the beam splitter arrangement before the process beam hits the photosensor as a corresponding partial beam.

16. The sensor device according to claim 1, further comprising:
a housing, wherein the housing comprises an optical input for introducing the process beam, wherein the beam splitter arrangement and the photosensor arrangements are arranged within the housing, and
a coupling device for coupling the sensor device to a laser machining head, wherein the coupling device is attached to the housing.

17. A laser machining system for performing a laser machining process, the laser machining system comprising:
a laser machining head configured to radiate a laser beam onto a workpiece in order to perform a laser machining process, and
the sensor device according to claim 1,
wherein the laser machining head includes at least one beam splitter arranged to couple out a process beam generated during the laser machining process and entering the laser machining head from the beam path of the laser beam to the sensor device.

18. The laser machining system according to claim 17, wherein the photosensors are each configured to generate a corresponding sensor signal based on the sensed intensity,
wherein the laser machining system further comprises a control unit arranged to evaluate the sensor signals from the photosensors.

19. The laser machining system according to claim 18, wherein the control unit is configured to perform closed-loop control of the laser machining process based on the received sensor signals.

20. The laser machining system according to claim 18, wherein the control unit is configured to combine the individual sensor signals of the photosensors of the first, second and/or third photosensor arrangements into a combined sensor signal, wherein combining is carried out by adding the sensor signal values of the individual sensor signals.

21. The laser machining system according to claim 20, wherein the combined sensor signal represents a total intensity or a mean intensity of an entire visible wavelength range, or
wherein the combined sensor signal represents a sum of the intensities of subsets of the visible wavelength ranges.

22. The laser machining system according to claim 18, wherein the control unit is configured to compare at least two of the individual sensor signals of the photosensors of the first, second and/or third photosensor arrangements with one another, wherein comparing is carried out by forming quotients of and/or subtracting the sensor signal values of the two individual sensor signals.
